(19) United States
(12) Patent Application Publication
(10) Pub. No.: US 2023/0239769 A1
(43) Pub. Date: Jul. 27, 2023

(54) Method and Apparatus for Transmitting System Parameters of Soft Access Device, Device and Medium

(71) Applicant: CHENGDU XGIMI TECHNOLOGY CO., LTD., Chengdu (CN)

(72) Inventors: Hao WU, Chengdu (CN); Lei YIN, Chengdu (CN)

(21) Appl. No.: 17/846,060

(22) Filed: Jun. 22, 2022

(30) Foreign Application Priority Data
Jan. 25, 2022 (CN) 202210082895.2

(51) Int. Cl. H04W 48/10; H04W 76/15; H04W 8/00

(52) U.S. Cl. CPC H04W 48/10; H04W 8/005; H04W 76/15; H04W 88/08

(57) ABSTRACT

Disclosed are a method and apparatus for transmitting system parameters of a soft access device, a device and a medium. A method for acquiring system parameters of a soft access device includes: receiving a broadcast message sent by the soft access device on a main link, a reduced neighbor report information element in the broadcast message including a multi-link device identifier, an identifier of a non-main link and a system parameter change count; sending a first message for requesting system parameters on the non-main link to the soft access device on the main link in a case that the received broadcast message indicates that a value of a system parameter change count corresponding to the non-main link is different from that of a system parameter change count received last time; and receiving a second message in response to the first message and sent by the soft access device on the main link.

### TECHNICAL FIELD

The disclosure relates to the field of communication, and in particular to a method and apparatus for transmitting system parameters of a soft access device, a device and a medium.

### BACKGROUND

802.11be system, also referred to as an extremely high throughput (EHT) system, is enhanced in functions by means of a series of system characteristics and multiple mechanisms to achieve extremely high throughput. As the use of wireless local area networks (WLANs) keeps growing, it is increasingly important to provide wireless data services in numerous environments (for example, homes, companies and hotspots). In particular, video traffic will still be the dominant traffic type in a large number of WLAN deployments. Due to the emergence of 4k and 8k videos (at an uncompressed rate of 20 Gbps), the throughput requirements of these applications are also evolving. Thus, novel high-throughput and low-latency applications such as virtual reality or augmented reality, gaming, remote office, and cloud computing will proliferate (for example, latency below 5 milliseconds for live gaming).

In view of high throughput and stringent real-time latency requirements of these applications, users expect higher throughput, higher reliability, less latency and jitter, and higher power efficiency when supporting the applications by means of WLANs. Users expect to improve integration with time-sensitive networks (TSNs) to support applications on heterogeneous Ethernet and wireless local area networks (LANs). 802.11be networks aim to ensure the competitiveness of the WLANs by further improving overall throughput and reducing latency, and further ensure backward compatibility and coexistence with legacy technology standards. 802.11 operating in 2.4 GHz, 5 GHz, and 6 GHz bands are compatible with devices.

### SUMMARY

In a first aspect, an embodiment of the disclosure provides a method for acquiring system parameters of a soft access device, the soft access device including a first logical access point operating on a primary link and a second logical access point operating on a non-primary link, where the method includes:
a broadcast message sent by the soft access device on the primary link is received, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
a first message is sent to the soft access device on the primary link in a case that the received reduced neighbor report information element indicates that a value of a system parameter change count corresponding to the non-primary link is different from that of a system parameter change count received previously, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
a second message in response to the first message and sent by the soft access device on the primary link is received, the second message including an identifier of the non-primary link, system parameters of the second logical access point operating on the non-primary link and a system parameter change count.

In an alternative embodiment, the first message further includes an instruction whether to request only updated system parameters and a system parameter change count corresponding to a state of local system parameters; and

the system parameters of the second logical access point operating on the non-primary link included in the second message are changed system parameters of the second logical access point between the system parameter change count in the second message and the system parameter change count corresponding to the state of the local system parameters in the first message in a case that the instruction in the first message requests only the updated system parameters.

In an alternative embodiment, after the receiving a broadcast message sent by the soft access device on the primary link and before the sending a first message, the method further includes:
determining whether the link indicated by the first link identifier is a non-primary link according to locally stored information and a value of a link identifier in the reduced neighbor report information element in a case that the multi-link device identifier in the received reduced neighbor report information element indicates that the neighboring logical access point is affiliated with the same device as the first logical access point sending the broadcast message; alternatively,
determining the link indicated by the first link identifier as the non-primary link in a case that the multi-link device identifier in the received reduced neighbor report information element indicates that the neighboring logical access point is affiliated with the same soft access device as the first logical access point sending the broadcast message and is a logical access point operating on the non-primary link in the soft access device.

In an alternative embodiment, the first message is a multi-link probe request message, and the second message is a multi-link probe response message.

In a second aspect, an embodiment of the disclosure provides a method for acquiring system parameters of a soft access device, the soft access device including a first logical access point operating on a primary link and a second logical access point operating on a non-primary link, where the method includes:
a broadcast message sent by the soft access device on the primary link is receiving, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, and the first parameter is used for indicating duration of sending updated system parameters of the second logical access point in the broadcast message of the first logical access point; and
the updated system parameters of the second logical access point is read within the duration indicated by a value of the first parameter in a case that the received reduced neighbor report information element indicates that a value of a system parameter change count corresponding to the non-primary link is different from that of a system parameter change count received previously and a value of the first parameter indicates that a subsequent broadcast message includes the updated system parameters of the second logical access point.

In an alternative embodiment, after the receiving a broadcast message sent by the soft access device on the primary link and before the reading the updated system parameters of the second logical access point, the method further includes:
it is determined whether the link indicated by the first link identifier is a non-primary link according to locally stored information and a value of a link identifier in the reduced neighbor report information element in a case that the multi-link device identifier in the received reduced neighbor report information element indicates that the neighboring logical access point is affiliated with the same device as the first logical access point sending the broadcast message; alternatively,
the link indicated by the first link identifier is determined as the non-primary link in a case that the multi-link device identifier in the received reduced neighbor report information element indicates that the neighboring logical access point is affiliated with the same soft access device as the first logical access point sending the broadcast message and is a logical access point operating on the non-primary link in the soft access device.

In a third aspect, an embodiment of the disclosure provides a method for sending system parameters of a soft access device, the soft access device including a first logical access point operating on a primary link and a second logical access point operating on a non-primary link, where the method includes:
a broadcast message sent by the soft access device on the primary link is sent, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
a first message sent by a terminal device on the primary link is received, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
a second message in response to the first message is sent to the terminal device on the primary link in a case that the identifier of the target multi-link device in the received first message indicates the device to which the first logical access point receiving the first message is affiliated with, the second message including an identifier of the non-primary link, system parameters of the second logical access point operating on the non-primary link and a system parameter change count.

In an alternative embodiment, the first message further includes an instruction whether to request only updated system parameters and a system parameter change count corresponding to a state of local system parameters; and

the system parameters of the second logical access point operating on the non-primary link included in the second message are changed system parameters of the second logical access point between the system parameter change count in the second message and the system parameter change count corresponding to the state of the local system parameters in the first message in a case that the instruction in the first message requests only the updated system parameters.

In an alternative embodiment, after the receiving a first message and before the sending the second message, the method further includes:
a timer is started; and
the second message is sent when time of the timer is up.

In an alternative embodiment, the multi-link device identifier in the reduced neighbor report information element indicates that the neighboring logical access point is affiliated with the same device as the first logical access point sending the broadcast message, or indicates that the neighboring logical access point is affiliated with the same soft access device as the first logical access point sending the broadcast message and is a logical access point operating on the non-primary link in the soft access device.

In an alternative embodiment, the first message is a multi-link probe request message, and the second message is a multi-link probe response message.

In a fourth aspect, an embodiment of the disclosure provides a method for sending system parameters of a soft access device, the soft access device including a first logical access point operating on a primary link and a second logical access point operating on a non-primary link, where the method includes:
a broadcast message on the primary link is sent, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, the first parameter is used for indicating duration of sending updated system parameters of the second logical access point in the broadcast message of the first logical access point, and
the broadcast message sent within the duration indicated by a value of the first parameter including the updated system parameters of the second logical access point.

In an alternative embodiment, the multi-link device identifier in the reduced neighbor report information element indicates that the neighboring logical access point is affiliated with the same device as the first logical access point sending the broadcast message, or indicates that the neighboring logical access point is affiliated with the same soft access device as the first logical access point sending the broadcast message and is a logical access point operating on the non-primary link in the soft access device.

In a fifth aspect, an embodiment of the disclosure provides an apparatus for acquiring system parameters of a soft access device, the soft access device including a first logical access point operating on a primary link and a second logical access point operating on a non-primary link, where the apparatus includes a parameter acquisition component, the parameter acquisition component is used for executing:
receiving a broadcast message sent by the soft access device on the primary link, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
sending a first message to the soft access device on the primary link in a case that the received reduced neighbor report information element indicates that a value of a system parameter change count corresponding to the non-primary link is different from that of a system parameter change count received previously, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
receiving a second message in response to the first message and sent by the soft access device on the primary link, the second message including an identifier of the non-primary link, system parameters of the second logical access point operating on the non-primary link and a system parameter change count.

In a sixth aspect, an embodiment of the disclosure provides an apparatus for acquiring system parameters of a soft access device, the soft access device including a first logical access point operating on a primary link and a second logical access point operating on a non-primary link, where the apparatus includes a parameter acquisition component, the parameter acquisition component is used for executing:
receiving a broadcast message sent by the soft access device on the primary link, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, and the first parameter is used for indicating duration of sending updated system parameters of the second logical access point in the broadcast message of the first logical access point; and
the updated system parameters of the second logical access point is read within the duration indicated by a value of the first parameter in a case that the received reduced neighbor report information element indicates that a value of a system parameter change count corresponding to the non-primary link is different from that of a system parameter change count received previously and a value of the first parameter indicates that a subsequent broadcast message includes the updated system parameters of the second logical access point.

In a seventh aspect, an embodiment of the disclosure provides an apparatus for acquiring system parameters of a soft access device, the soft access device including a first logical access point operating on a primary link and a second logical access point operating on a non-primary link, where the apparatus includes a parameter sending component, the parameter sending component is used for executing:
sending a broadcast message sent by the soft access device on the primary link, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
receiving a first message sent by a terminal device on the primary link, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
sending a second message in response to the first message to the terminal device on the primary link in a case that the identifier of the target multi-link device in the received first message indicates the device to which the first logical access point receiving the first message is affiliated with, the second message including an identifier of the non-primary link, system parameters of the second logical access point operating on the non-primary link and a system parameter change count.

In an eighth aspect, an embodiment of the disclosure provides an apparatus for acquiring system parameters of a soft access device, the soft access device including a first logical access point operating on a primary link and a second logical access point operating on a non-primary link, where the apparatus includes a parameter sending component, the parameter sending component is used for executing:
sending a broadcast message on the primary link, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, the first parameter is used for indicating duration of sending updated system parameters of the second logical access point in the broadcast message of the first logical access point, and
the broadcast message sent within the duration indicated by a value of the first parameter including the updated system parameters of the second logical access point.

In a ninth aspect, an embodiment of the disclosure provides an electronic device, including a memory, a processor and a computer program stored on the memory, where the processor executes the computer program to implement steps of the method of any one of the first aspect to the fourth aspect.

In a tenth aspect, an embodiment of the disclosure provides a computer-readable storage medium, storing a computer program, where the computer program implements steps of the method of any one of the first aspect to the fourth aspect when executed by a processor.

In an eleventh aspect, an embodiment of the disclosure provides a computer program product, including a command, where the command implements steps of the method of any one of the first aspect to the fourth aspect when executed by a processor.

It should be noted that the apparatus of the fifth aspect is used for implementing the method of the first aspect, the apparatus of the sixth aspect is used for implementing the method of the second aspect, the apparatus of the seventh aspect is used for implementing the method of the third aspect, the apparatus of the eighth aspect is used for implementing the method of the fourth aspect, the electronic device of the ninth aspect, the storage medium of the tenth aspect and the computer program product of the eleventh aspect are used for executing the method of any one of the first aspect above to the fourth aspect above, and therefore, the same beneficial effects of the method described in the first aspect, the second aspect, the third aspect, or the fourth aspect may be achieved, which are not described in the embodiments of the disclosure.

The embodiments of the disclosure enables the terminal device connected to the soft access device to acquire the updated system parameters in time by monitoring system parameter changes on the non-primary link of the soft access device and acquiring the changed system parameters, thereby avoiding access failure of the terminal device on the non-primary link, and guaranteeing communication between the terminal device and the soft access device.

### BRIEF DESCRIPTION OF THE DRAWINGS

FIG. 1 is an architectural schematic diagram of a communication system provided in an embodiment of the disclosure;

FIG. 2 is a schematic diagram of a method for transmitting system parameters of a soft access device provided in an embodiment of the disclosure; and

FIG. 3 is a structural schematic diagram of an electronic device provided in an embodiment of the disclosure.

### DETAILED DESCRIPTION OF THE EMBODIMENTS

In order to make those skilled in the art better understand the technical solutions in the disclosure, the technical solutions in embodiments of the disclosure will be clearly and completely described below. Apparently, the embodiments described are merely some of, rather than all of, the embodiments of the disclosure. It should be understood that the particular embodiments described herein are merely illustrative of the disclosure and are not intended to limit the disclosure. Although the contents disclosed in the disclosure are introduced according to one or several exemplary examples, it should be understood that all aspects of these contents disclosed may also constitute a complete technical solution separately. The following embodiments and the features in the embodiments may be combined with each other without conflict.

In the embodiments of the disclosure, “at least one” refers to one or more, and “plurality” refers to two or more. In order to conveniently and clearly describe the technical solutions of the embodiments of the disclosure, in the embodiments of the disclosure, the words “first”, “second”, etc. are used to distinguish the same or similar items having substantially the same function and effect, and those skilled in the art will understand that the words “first”, “second”, etc. do not limit the number and order of execution, are only used to illustrate and distinguish description objects, has no difference in order, also do not represent a special limit on the number of devices in the embodiments of the disclosure, and may not constitute any limit on the embodiments of the disclosure.

It should be noted that a multi-link device includes a plurality of logical entities, where each of the logical entities transmits data by means of a link, and includes an independent data receiving and transmitting component. A single-link device has only one logical entity and only one media access control (MAC) address, and the multi-link device has one MAC address, and each of the logical entities belonging to the multi-link device has one MAC address. For example, one multi-link device runs with the three logical entities, such that there are four MAC addresses on the physical device, one address is an address of the multi-link device, and each of the three logical entities has one MAC address. In the embodiments of the disclosure, logical entities in a terminal device are referred to as logical terminals, and logical entities in an access device are referred to as logical access points.

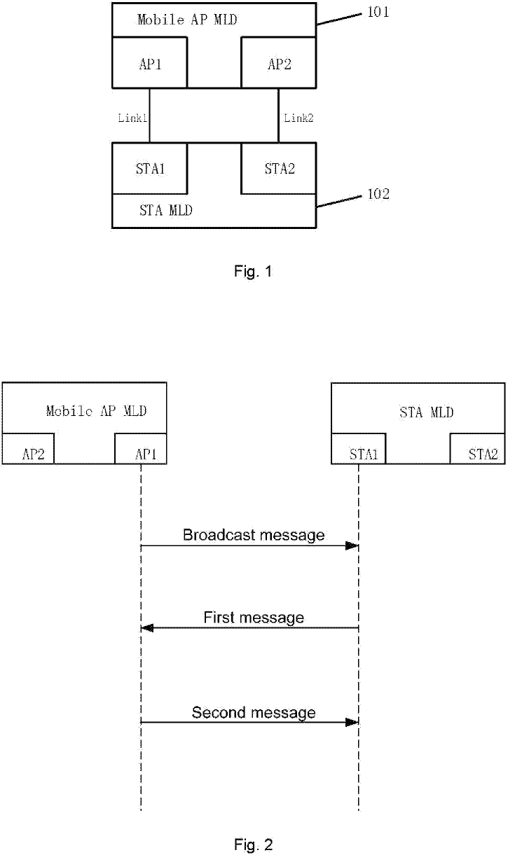

FIG. 1 is an architectural schematic diagram of a communication system provided in an embodiment of the disclosure. As shown in FIG. 1, the communication system includes a terminal device Mobile access point (AP) multi-link device (MLD)101 and a terminal device station (STA) MLD102, where the terminal device Mobile AP MLD 101 is a soft access device, and establishes two logical access points AP1 and AP2, where the AP1 operates on a primary link 1, the AP1 sends a broadcast message, for example, a Beacon message and a probe response message, and the AP2 operates on a non-primary link 2, the AP2 does not send the broadcast message, and both the AP1 and the AP2 may perform data transmission with a connected terminal; and the terminal device STA MLD102 includes two logical terminals STA1 and STA2, and a STA MLD is connected to a Mobile AP MLD, where the STA1 is connected to the AP1 on the primary link 1, and the STA2 is connected to the AP2 on the non-primary link 2. It should be understood that FIG. 1 is only the architectural schematic diagram of the communication system, and that the number of access devices and the number of terminal devices in the communication system are not limited in the embodiment of the disclosure, and the number of logical entities in a multi-link device is not limited. Those skilled in the art will understand that in accordance with the principles and functions described herein, the term “access point (AP)” according to the disclosure may further be used to describe an access port or any other device capable of receiving and transmitting wireless signals within a network architecture, and therefore, the use of the access points is merely exemplary.

FIG. 2 is a schematic diagram of a method for transmitting system parameters of a soft access device provided in an embodiment of the disclosure, where the transmitting herein includes sending and acquiring. As shown in FIG. 2, the method for sending and acquiring system parameters of a soft access device includes:

201, after system parameters of an AP2 are updated, send, by an AP1, a broadcast message, for example, a Bea con message or a Probe response message, which includes a reduced neighbor report information element which is used for indicating information of a neighboring logical access point, and includes the following parameters:
an MLD identifier (ID), which is used for identifying a device to which the neighboring logical access point is affiliated with, where if a value of the MLD ID is set as 0, it is indicated that the neighboring logical access point is affiliated with the same device as the AP1 sending the broadcast message, i.e., the same Mobile AP MLD; if the value of the MLD ID is set as 1, it is indicated that the neighboring logical access point does not belong to the same device as the AP1 sending the broadcast message; and alternatively, the value of the MLD ID may further be set as X (a predefined value), it is indicated that the neighboring logical access point is affiliated with the same soft access device as the AP1 sending the broadcast message and is a logical access point operating on a non-primary link in the soft access device;
a link ID, which is used for identifying a link corresponding to the neighboring logical access point, is configured as an identifier of the non-primary link in an embodiment of the disclosure, and may correspond to a logical access point AP2 operating on the non-primary link on the Mobile AP MLD; and
a base station subsystem (BSS) parameters change count, which is a system parameter change count, and is used for identifying a state of update of system parameters, where when a value of a parameter previously received by a terminal is the same as that of a parameter currently sent, it is indicated that the access point does not update the system parameters; and when the value of the parameter previously received by the terminal is different from that of the parameter currently sent, the access point updated the system parameter.

202, after a STA1 receives the broadcast message sent by the AP1, if the received reduced neighbor report information element indicates that a value of a BSS parameters change count corresponding to the non-primary link is different from that of a BSS parameters change count received previously, send, by the STA1, a first message to the AP1, the first message is used for requesting system parameters of a logical access point, and including the following parameters: a receiver address, which is set as an address of the AP1;
a link ID, which is used for identifying a link corresponding to the requested logical access point, is set as the identifier of the non-primary link in the embodiment of the disclosure, and may correspond to the logical access point AP2 operating on the non-primary link on the Mobile AP MLD; and
an MLD ID, which is used for identifying a device to which the requested logical access point is affiliated with, where if a value of the MLD ID is set as 0, it is indicated that the device to which the requested logical access point is affiliated with is a device to which the AP1 receiving the message is affiliated with, i.e., the same Mobile AP MLD; and if the value of the MLD ID is set as 1, it is indicated that the device to which the requested logical access point is affiliated with is not the device to which the AP1 receiving the message is affiliated with.

Alternatively, the STA1 further determines whether the link indicated by the link ID in the received reduced neighbor report information element is a non-primary link. Exemplarily, a method for determining a non-primary link by the STA1 is as follows: if a value of the MLD ID is 0, whether the link is a non-primary link is determined according to locally stored information and a value of the link ID, or if the value of the MLD ID is X, the link is determined as the non-primary link.

203, determine a target device (the device to which the requested logical access point is affiliated with) as a device to which the AP1 is affiliated with, i.e., the Mobile AP MLD, according to the value of the MLD ID in the first message after the AP1 receives the first message, where specifically, when the MLD ID=0, the target device is determined as the device to which the target device is affiliated with, and otherwise, the target device is determined as a device to which the AP1 does not belong, and the following operations are not executed:
1) construct a second message in response to the first message, the second message including system parameters of a logical access point corresponding to the parameter link ID in a mobile AP MLD, and send the second message; alternatively,
2) construct the second message in response to the first message, the second message including the system parameters of the logical access point corresponding to the parameter link ID in the mobile AP MLD, start a delay timer T1, and send the second message when time of the T1 is up.

The first message sent by the terminal may be prevented from being frequently responded by using the delay timer T1, and the second message may be uniformly sent as a response to the request of the terminal after a period of time is accumulated, thereby reducing signaling overhead, and saving power consumption of the mobile AP MLD. Exemplarily, the second message includes the following parameters:
a receiver address, which is set as an address of the STA1;
a link ID, which is used for identifying a link corresponding to a logical access point corresponding to the sent system parameters, is set as the identifier of the non-primary link in the embodiment of the disclosure, and may correspond to the logical access point AP2 operating on the non-primary link on the Mobile AP MLD;
an AP profile, which is system parameters of an access point operating on a link corresponding to the link ID; and
a BSS parameters change count, which is a system parameter change count, and corresponds to a state of the system parameters of the access point operating on the link corresponding to the link ID when the second message is sent.

204, receive, by the logical terminal STA1 of the STA MLD, the second message, and update, by the logical terminal STA2 of the STA MLD, the locally saved system parameters of the AP2 to the system parameters in the AP profile received by the STA1, and a locally saved value of a previous system parameter change count corresponding to the AP2 to a value of the parameter BSS parameters change count received by the STA1.

205, use, by the logical terminal STA2 of the STA MLD, the updated system parameters to perform data communication with the AP2.

In some embodiments, a first message may further include an instruction whether to request only the updated system parameters and a system parameter change count corresponding to a state of local system parameters. Exemplarily, the first message includes the following parameters:
a receiver address, which is set as an address of an AP1;
a link ID, which is used for identifying a link corresponding to a requested logical access point, is configured as an identifier of a non-primary link in the embodiments of the disclosure, and may correspond to a logical access point AP2 operating on the non-primary link on a Mobile AP MLD;
an MLD ID, which is used for identifying a device to which the requested logical access point is affiliated with, where if the value of the MLD ID is set as 0, it is indicated that the device to which the requested logical access point is affiliated with is a device to which an AP1 receiving the message is affiliated with; and if the value of the MLD ID is set as 1, it is indicated that the device to which the requested logical access point is affiliated with is not the device to which the AP1 receiving the message is affiliated with;
updated BSS parameters, which are system parameters whether to only request updated system parameters, where a value of the updated BSS parameters is set as 1, it is indicated that the updated system parameters are only requested; and otherwise, the value of the updated BSS parameters is set to be 0;
a current change count, which is set as a system parameter change count corresponding to a state of local system parameters; and
complete parameters, which indicate whether all or part of the system parameters are requested, where for example, when a value of the parameter, updated BSS parameters, is 1, a value of the parameter, complete parameters, is set as 0, which indicates that part of the system parameters are requested; and when the value of the parameter updated BSS parameters is 0, the value of the parameter, complete parameters, may be set as 1 or 0, which may indicate that all the system parameters are requested, or may indicate that part of the system parameters are requested

Correspondingly, in step 203, the target device is determined as the device to which the target device is affiliated with, i.e., the Mobile AP MLD, according to the value of the MLD ID in the first message after the AP1 receives the first message, where specifically, when the MLD ID=0, the target device is determined as the device to which the target device is affiliated with, and otherwise, the target device is not determined as the device to which the target device is affiliated with, and the following operations are not executed:
1) construct a second message in response to the first message, where if a value of the received parameter updated BSS parameters is 1, the second message includes system parameters, changed between a current system parameter change count and a system parameter change count indicated by the current change count, of the logical access point corresponding to the parameter link ID in the Mobile AP MLD, and
   if the value of the received parameter updated BSS parameters is 0, the second message includes all system parameters of the logical access point corresponding to the parameter link ID in the mobile AP MLD or part of requested system parameters; and
   send the second message;
   alternatively,
2) construct a second message in response to the first message, where if the value of the received parameter updated BSS parameters is 1, the second message includes system parameters, changed between the current system parameter change count and the system parameter change count indicated by the current change count, of the logical access point corresponding to the parameter link ID in the Mobile AP MLD, and
   if the value of the received parameter updated BSS parameters is 0, the second message includes all system parameters of the logical access point corresponding to the parameter link ID in the mobile AP MLD or part of requested system parameters; and
   start a delay timer T1, and send the second message when time of the T1 is up.

Alternatively, the first message may be a probe request message (e.g., a ML probe request message), and correspondingly, the second message may be a probe response message (e.g., an ML probe response message). In this embodiment, the parameter receiver address in the probe response message may be set to a broadcast address.

In some other embodiments, a reduced neighbor report information element in a broadcast message sent by an AP1 may further include a first parameter, where the first parameter is used for indicating duration of sending updated system parameters of an AP2 in the broadcast message of the AP1; and then the broadcast message sent by the AP1 within the duration indicated by a value of the first parameter includes the updated system parameters of the AP2. Exemplarily, the reduced neighbor report information element includes the following parameters:
an MLD ID, which is used for identifying a device to which the neighboring logical access point is affiliated with, where if a value of the MLD ID is set as 0, it is indicated that the neighboring logical access point is affiliated with the same device as the AP1 sending the broadcast message, i.e., the same Mobile AP MLD; if the value of the MLD ID is set as 1, it is indicated that the neighboring logical access point does not belong to the same device as the AP1 sending the broadcast message; and alternatively, the value of the MLD ID may further be set as X (a predefined value), it is indicated that the neighboring logical access point is affiliated with the same soft access device as the AP1 sending the broadcast message and is a logical access point of the soft access device operating on a non-primary link;
a link ID, which is used for identifying a link corresponding to the neighboring logical access point, is configured as an identifier of the non-primary link in an embodiment of the disclosure, and may correspond to a logical access point AP2 operating on the non-primary link on the Mobile AP MLD;
a BSS parameters change count, which is a system parameter change count, and is used for identifying a state of update of system parameters, where when a value of a parameter previously received by a terminal is the same as that of a parameter currently sent, it is indicated that the access point does not update the system parameters; and when the value of the parameter previously received by the terminal is different from that of the parameter currently sent, the access point updated the system parameter;
a duration count, which is duration of sending updated system parameters of the AP2 in the broadcast message of the AP1, where for example, if a value of the duration count is 7, periodic sending in next 7 broadcast messages is indicated, and when the value of the duration count is 0, it is indicated that sending in the broadcast message is stopped; and of course, there are other count modes having the same effect, and the same effect is achieved as long as duration to broadcast and update the system parameters may be indicated.

In this embodiment, after receiving the broadcast message sent by the AP1, the STA1 does not need to send the first message for requesting the system parameters on the non-primary link to the AP1, if the received reduced neighbor report information element indicates that a value of a BSS parameters change count corresponding to the non-primary link is different from that of a BSS parameters change count received previously, and a value of the parameter duration count indicates that a subsequent broadcast message includes updated system parameter of a second logical access point, the updated system parameters of the second logical access point are read within the duration indicated by the value of the parameter duration count; the logical terminal STA2 of the STA MLD updates locally stored system parameters of the AP2 to updated system parameters received by the STA1, and updates a locally stored value of a previous system parameter change count corresponding to the AP2 to a value of the parameter BSS parameters change count received by the STA1; and the logical terminal STA2 of the STA MLD uses the updated system parameters to perform data communication with the AP2.

An embodiment of the disclosure further provides an apparatus for acquiring system parameters of a soft access device, the soft access device including a first logical access point operating on a primary link and a second logical access point operating on a non-primary link, where the apparatus includes a parameter acquisition component, the parameter acquisition component is used for executing:
receive a broadcast message sent by the soft access device on the primary link, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
send a first message to the soft access device on the primary link in a case that the received reduced neighbor report information element indicates that a value of a system parameter change count corresponding to the non-primary link is different from that of a system parameter change count received previously, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
receive a second message in response to the first message and sent by the soft access device on the primary link, the second message including an identifier of the non-primary link, system parameters of the second logical access point operating on the non-primary link and a system parameter change count.

In an optional example, those skilled in the art may understand that the above apparatus may specifically be the STA MLD in the above embodiment, and that the apparatus may be used for executing various flows and/or steps corresponding to the STA MLD in the above method, which is not described herein in order to avoid repetition.

An embodiment of the disclosure provides an apparatus for acquiring system parameters of a soft access device, the soft access device including a first logical access point operating on a primary link and a second logical access point operating on a non-primary link, where the apparatus includes a parameter acquisition component, the parameter acquisition component is used for executing:
receive a broadcast message sent by the soft access device on the primary link, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, and the first parameter is used for indicating duration of sending updated system parameters of the second logical access point in the broadcast message of the first logical access point; and
read the updated system parameters of the second logical access point within the duration indicated by a value of the first parameter in a case that the received reduced neighbor report information element indicates that a value of a system parameter change count corresponding to the non-primary link is different from that of a system parameter change count received previously and a value of the first parameter indicates that a subsequent broadcast message includes the updated system parameters of the second logical access point.

In an optional example, those skilled in the art may understand that the above apparatus may specifically be the STA MLD in the above embodiment, and that the apparatus may be used for executing various flows and/or steps corresponding to the STA MLD in the above method, which is not described herein in order to avoid repetition.

An embodiment of the disclosure provides an apparatus for sending system parameters of a soft access device, the soft access device including a first logical access point operating on a primary link and a second logical access point operating on a non-primary link, where the apparatus includes a parameter sending component, the parameter sending component is used for executing:
send a broadcast message sent by the soft access device on the primary link, the broadcast message including a reduced neighbor report information element, the reduced neighbor report information element is used for indicating information of a neighboring logical access point and including a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
receive a first message sent by a terminal device on the primary link, the first message is used for requesting system parameters of a logical access point and including a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
send a second message in response to the first message to the terminal device on the primary link in a case that the identifier of the target multi-link device in the received first message indicates the device to which the first logical access point receiving the first message is affiliated with, the second message including an identifier of the non-primary link, system parameters of the second logical access point operating on the non-primary link and a system parameter change count.

In an optional example, those skilled in the art may understand that the above apparatus may specifically be the Mobile AP MLD in the above embodiment, and that the apparatus may be used for executing various flows and/or steps corresponding to the Mobile AP MLD in the above method, which is not described herein in order to avoid repetition.

An embodiment of the disclosure provides an apparatus for sending system parameters of a soft access device, the soft access device including a first logical access point operating on a primary link and a second logical access point operating on a non-primary link, where the apparatus includes a parameter sending component, the parameter sending component is used for executing:
send a broadcast message on the primary link, the broadcast message including a reduced neighbor report information element, the reduced neighbor report information element is used for indicating information of a neighboring logical access point and including a multi-link device identifier, a first link identifier, a system parameter change count and a first parameter, the multi-link device identifier is used for identifying a device to which the neighboring logical access point is affiliated with, the first link identifier is used for identifying a link corresponding to the neighboring logical access point and being configured as an identifier of the non-primary link, the system parameter change count is used for identifying a state of update of system parameters, the first parameter is used for indicating duration of sending updated system parameters of the second logical access point in the broadcast message of the first logical access point, and
the broadcast message sent within the duration indicated by a value of the first parameter including the updated system parameters of the second logical access point.

In an optional example, those skilled in the art may understand that the above apparatus may specifically be the Mobile AP MLD in the above embodiment, and that the apparatus may be used for executing various flows and/or steps corresponding to the Mobile AP MLD in the above method, which is not described herein in order to avoid repetition.

It should be understood that the apparatuses herein are represented in the form of functional components. The term “component” herein may refer to an application specific integrated circuit (ASIC), an electronic circuit, a processor (e.g., a shared processor, a proprietary processor, or a group processor, etc.) for executing one or more software or firmware programs, a memory, a merged logical circuit, and/or other appropriate components to support described functions. The above apparatus has the function of implementing the corresponding steps in the above method. The above functions may be implemented by hardware or by executing corresponding software by the hardware. The hardware or software includes one or more components corresponding to the functions above. In the embodiment of the disclosure, the apparatus may be a chip or a system on a chip, for example, a system on chip (SoC), which is not limited herein by the disclosure.

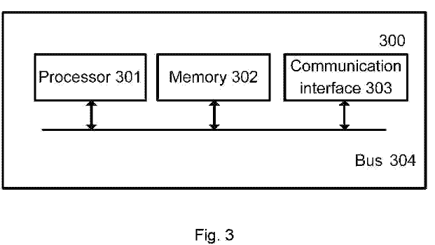

An embodiment of the disclosure further provides an electronic device. FIG. 3 is a structural schematic diagram of the electronic device provided in the embodiment of the disclosure. As shown in FIG. 3, the device 300 includes a processor 301, a memory 302, and a communication interface 303, where the processor 301, the memory 302 and the communication interface 303 communicate with one another by means of a bus 304, and the memory 302 stores a command executable by the processor

301, and the command is loaded and executed by the processor 301 to control the communication interface 303 to send and/or receive a signal.

It should be understood that the device 300 may specifically be the STA MLD or the Mobile AP MLD in the above embodiment, or that the functions of the STA MLD or the Mobile AP MLD in the above embodiment may be integrated in the device 300, and the device 300 may be used for executing various steps and/or flows corresponding to the STA MLD or the Mobile AP MLD in the above embodiment. Alternatively, the memory 302 may include a read-only memory and a random access memory and provide commands and data for the processor 301. The memory 302 may further include, in part, a non-volatile random access memory. For example, the memory 302 may further store device type information. The processor 301 may be used for executing the command stored in the memory 301, and when the processor 301 executes the command, the processor 301 may execute corresponding various steps and/or flows in the above method embodiments.

It should be understood that the processor may be a central processing unit (CPU) or other general-purpose processors, a digital signal processor (DSP), an application specific integrated circuit (ASIC), a field-programmable gate array (FPGA), or other programmable logic devices, a discrete gate or transistor logic device, a discrete hardware component, etc. in the embodiment of the disclosure. The general-purpose processor may be a microprocessor, or the processor may be any conventional processor, etc.

In an implementation process, each step of the above method may be completed by means of an integrated logical circuit of hardware in the processor or the command in the form of software. Steps of the method disclosed in the embodiments of the disclosure may be directly embodied as being completed by execution by the hardware processor, or by execution of combination of hardware and software components in the processor. A software component may be located in storage media, such as the random access memory, a flash memory, the read-only memory, a programmable read-only memory, or an electrically erasable programmable memory, a register, etc., which are mature in the field. The storage media are located in the memory, and the processor executes the command in the memory and completes the steps of the above method in combination with hardware of the processor, which is not described in detail herein in order to avoid repetition.

The above embodiments may be implemented in whole or in part by software, hardware, firmware, or any other combination. When implemented in software, the above embodiments may be implemented in whole or in part in the form of a computer program product. The computer program product includes one or more computer commands or a computer program. The flows or functions according to the embodiments of the disclosure are generated in whole or in part when the computer commands or the computer program are loaded or executed on a computer. The computer may be a general-purpose computer, a special-purpose computer, a computer network, or other programmable apparatuses. The computer commands may be stored in computer-readable storage media or transmitted from one computer-readable storage medium to another computer-readable storage medium, for example, the computer commands may be transmitted from one website, computer, server, or data center by wired (e.g., infrared, wireless, microwave, etc.) means to another website, computer, server, or data center. The computer-readable storage medium may be any available media that may be accessed by a computer or data storage devices of servers, data centers, etc. that include one or more sets of available media. The available media may be magnetic media (e.g., floppy disks, hard disks and magnetic tapes), optical media (e.g., digital video disks (DVDs)), or semiconductor media. The semiconductor media may be solid state disks.

The embodiments of the disclosure enables the terminal device connected to the soft access device to acquire the updated system parameters in time by monitoring system parameter changes on the non-primary link of the soft access device and acquiring the changed system parameters, thereby avoiding access failure of the terminal device on the non-primary link, and guaranteeing communication between the terminal device and the soft access device.

It should be understood that in various embodiments of the disclosure, the size of the sequence numbers of the processes above does not imply the order of execution, and the order of execution of the processes should be determined by their function and inherent logic, and should not be construed as limiting the implementation of the embodiments of the disclosure. The component described as a separable component may be physically separated or not, and a component shown as a component may be a physical component or not, that is, may be located at one place or may also be distributed on a plurality of network components, and part or all of components are selected to achieve the objective of the solutions of the embodiments of the disclosure according to actual requirements.

In the several embodiments provided in the disclosure, it should be understood that the devices, apparatuses and methods disclosed may be

implemented in other ways. For example, the apparatus embodiments described above are merely schematic, for example, division of the components is merely a kind of division of logical functions, there may be other division modes in actual implementation, and for example, one component may be divided into a plurality of components or assemblies, or the plurality of components or assemblies may be combined or integrated into another system, or some features may be omitted or not conducted. In another aspect, the coupling or direct coupling or communicative connection to one another shown or discussed may be achieved by means of some interfaces, and the indirect coupling or communicative connection of apparatuses or components may be in an electrical form, a mechanical form, or other forms.

Those of ordinary skill in the art will appreciate that the components and algorithm steps of the examples described in connection with the embodiments disclosed herein may be implemented in electronic hardware, or a combination of computer software and electronic hardware. Whether these functions are executed in hardware or software depends on the specific application and design constraints of the technical solutions. Those skilled in the art may use different methods to implement functions described for each particular application, but such implementation should not be considered to go beyond the scope of the disclosure.

What is described above is merely specific implementations of the disclosure, but the scope of protection of the disclosure is not limited thereto, and any changes or substitutions, that may readily occur to those skilled in the art, within the scope of technology disclosed in the disclosure should all fall within the scope of protection of the disclosure. Therefore, the scope of protection of the disclosure should be subject to a protection scope of the claims.

1. A method for acquiring system parameters of a soft access device, the soft access device comprising a first logical access point operating on a primary link and a second logical access point operating on a non-primary link, wherein the method comprises:
receiving a broadcast message sent by the soft access device on the primary link, the broadcast message comprising a reduced neighbor report information element, the reduced neighbor report information element is used for indicating information of a neighboring logical access point and comprising a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
sending a first message to the soft access device on the primary link in a case that a received reduced neighbor report information element indicates that a value of a system parameter change count corresponding to the non-primary link is different from a value of a system parameter change count received previously, the first message is used for requesting system parameters of a logical access point and comprising a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
receiving a second message in response to the first message and sent by the soft access device on the primary link, the second message comprising an identifier of the non-primary link, system parameters of the second logical access point operating on the non-primary link and a system parameter change count.

2. The method for acquiring system parameters of the soft access device as claimed in claim 1, wherein the first message further comprises a system parameter change count corresponding to a state of local system parameters and an instruction whether to request only updated system parameters; and
in a case that the instruction in the first message requests only the updated system parameters, system parameters of the second logical access point operating on the non-primary link comprised in the second message are changed system parameters of the second logical access point between the system parameter change count in the second message and the system parameter change count corresponding to the state of the local system parameters in the first message.

3. The method for acquiring system parameters of the soft access device as claimed in claim 1, wherein after the receiving the broadcast message sent by the soft access device on the primary link and before sending the first message, the method further comprises:
determining whether a link indicated by the first link identifier is the non-primary link according to locally stored information and a value of a link identifier in the reduced neighbor report information element in a case that the multi-link device identifier in the received reduced neighbor report information element indicates that the neighboring logical access point is affiliated with the same device as the first logical access point sending the broadcast message; alternatively,
determining the link indicated by the first link identifier as the non-primary link in a case that the multi-link device identifier in the received reduced neighbor report information element indicates that the neighboring logical access point is affiliated with the same soft access device as the first logical access point sending the broadcast message, and the neighboring logical access point is a logical access point operating on the non-primary link in the soft access device.

4. The method for acquiring system parameters of the soft access device as claimed in claim 1, wherein the first message is a multi-link probe request message, and the second message is a multi-link probe response message.

5. The method for acquiring system parameters of the soft access device as claimed in claim 1, wherein the reduced neighbor report information element comprises a first parameter, the first parameter is used for indicating duration of sending updated system parameters of the second logical access point in the broadcast message of the first logical access point; and the method further comprises:
reading the updated system parameters of the second logical access point within the duration indicated by a value of the first parameter in a case that the received reduced neighbor report information element indicates that the value of a system parameter change count corresponding to the non-primary link is different from the value of the system parameter change count received previously and the value of the first parameter indicates that a subsequent broadcast message comprises the updated system parameters of the second logical access point.

6. The method for acquiring system parameters of the soft access device as claimed in claim 5, wherein after the receiving the broadcast message sent by the soft access device on the primary link and before the reading the updated system parameters of the second logical access point, the method further comprises:
determining whether the link indicated by the first link identifier is the non-primary link according to locally stored information and the value of a link identifier in the reduced neighbor report information element in a case that the multi-link device identifier in the received reduced neighbor report information element indicates that the neighboring logical access point is affiliated with the same device as the first logical access point sending the broadcast message; alternatively,
determining the link indicated by the first link identifier as the non-primary link in a case that the multi-link device identifier in the received reduced neighbor report information element indicates that the neighboring logical access point is affiliated with the same soft access device as the first logical access point sending the broadcast message and is a logical access point operating on the non-primary link in the soft access device.

7. A method for sending system parameters of a soft access device, the soft access device comprising a first logical access point operating on a primary link and a second logical access point operating on a non-primary link, wherein the method comprises:
sending a broadcast message on the primary link, the broadcast message comprising a reduced neighbor report information element, the reduced neighbor report information element is used for indicating information of a neighboring logical access point and comprising a multi-link device identifier, a first link identifier and a system parameter change count, the multi-link device identifier is used for identifying a device to which the neighboring logical access point is affiliated with, the first link identifier is used for identifying a link corresponding to the neighboring logical access point and being configured as an identifier of the non-primary link, and the system parameter change count is used for identifying a state of update of system parameters;
receiving a first message sent by a terminal device on the primary link, the first message is used for requesting system parameters of a logical access point and comprising a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
sending a second message in response to the first message to the terminal device on the primary link in a case that the identifier of the target multi-link device in a received first message indicates the device to which the first logical access point receiving the first message is affiliated with, the second message comprising an identifier of the non-primary link, system parameters of the second logical access point operating on the non-primary link and a system parameter change count.

8. The method for sending system parameters of the soft access device as claimed in claim 7, wherein the first message further comprises a system parameter change count corresponding to a state of local system parameters and an instruction whether to request only updated system parameters; and
system parameters of the second logical access point operating on the non-primary link comprised in the second message are changed system parameters of the second logical access point between the system parameter change count in the second message and the system parameter change count corresponding to the state of the local system parameters in the first message in a case that the instruction in the first message requests only the updated system parameters.

9. The method for sending system parameters of the soft access device as claimed in claim 7, wherein after the receiving a first message and before the sending the second message, the method further includes:
starting a timer; and
sending the second message when time of the timer is up.

10. The method for sending system parameters of the soft access device as claimed in claim 7, wherein the multi-link device identifier in the reduced neighbor report information element indicates that the neighboring logical access point is affiliated with the same device as the first logical access point sending the broadcast message, or indicates that the neighboring logical access point is affiliated with the same soft access device as the first logical access point sending the broadcast message and is a logical access point operating on the non-primary link in the soft access device.

11. The method for sending system parameters of a soft access device as claimed in claim 7, wherein the first message is a multi-link probe request message, and the second message is a multi-link probe response message.

12. The method for sending system parameters of the soft access device as claimed in claim 7, wherein the reduced neighbor report information element further comprises a first parameter, the first parameter is used for indicating duration of sending updated system parameters of the second logical access point in the broadcast message of the first logical access point, and the broadcast message sent within the duration indicated by a value of the first parameter comprising the updated system parameters of the second logical access point.

13. The method for sending system parameters of the soft access device as claimed in claim 12, wherein the multi-link device identifier in the reduced neighbor report information element indicates that the neighboring logical access point is affiliated with the same device as the first logical access point sending the broadcast message, or indicates that the neighboring logical access point is affiliated with the same soft access device as the first logical access point sending the broadcast message and is a logical access point operating on the non-primary link in the soft access device.

14. An apparatus for acquiring system parameters of a soft access device, the soft access device comprising a first logical access point operating on a primary link and a second logical access point operating on a non-primary link, wherein the apparatus comprises a parameter acquisition module, the parameter acquisition module is used for executing:
receiving a broadcast message sent by the soft access device on the primary link, the broadcast message comprising a reduced neighbor report information element, the reduced neighbor report information element is used for indicating information of a neighboring logical access point and comprising a multi-link device identifier, a first link identifier and a system parameter change count, the multi-link device identifier is used for identifying a device to which the neighboring logical access point is affiliated with, the first link identifier is used for identifying a link corresponding to the neighboring logical access point and configured as an identifier of the non-primary link, and the system parameter change count is used for identifying a state of update of system parameters;
sending a first message to the soft access device on the primary link in a case that the received reduced neighbor report information element indicates that a value of a system parameter change count corresponding to the non-primary link is different from a value of a system parameter change count received previously, the first message is used for requesting system parameters of a logical access point and comprising a second link identifier and an identifier of a target multi-link device, the second link identifier is used for identifying a link corresponding to a requested logical access point and being configured as an identifier of the non-primary link, and the identifier of the target multi-link device is used for identifying a device to which the requested logical access point is affiliated with and being configured to indicate a device to which the first logical access point receiving the first message is affiliated with; and
receiving a second message in response to the first message and sent by the soft access device on the primary link, the second message comprising an identifier of the non-primary link, system parameters of the second logical access point operating on the non-primary link and a system parameter change count.

15. The apparatus for acquiring system parameters of the soft access device as claimed in claim 14, wherein the reduced neighbor report information element comprises a first parameter, the first parameter is used for indicating duration of sending updated system parameters of the second logical access point in the broadcast message of the first logical access point; the parameter acquisition module is used for executing:
reading the updated system parameters of the second logical access point within the duration indicated by a value of the first parameter in a case that the received reduced neighbor report information element indicates that a value of the system parameter change count corresponding to the non-primary link is different from that of a system parameter change count received previously and a value of the first parameter indicates that a subsequent broadcast message comprises the updated system parameters of the second logical access point.

16. An electronic device, comprising a memory, a processor and a computer program stored on the memory, wherein the processor executes the computer program to implement steps of the method as claimed in claim 1.

17. A computer-readable storage medium, storing a computer program, wherein the computer program implements steps of the method as claimed in claim 1 when executed by a processor.
